(19) United States
(12) Patent Application Publication
(10) Pub. No.: US 2026/0311688 A1
(43) Pub. Date: Oct. 8, 2026

(54) Detecting and Reducing Hallucinations In Audio Large Language Models

(71) Applicant: GDM Holding LLC, Mountain View, CA (US)

(72) Inventors: Quan Wang, Hoboken, NJ (US); Qingyun Dou, New York City, NY (US); Yonghui Xiao, Mountain View, CA (US); Fadi Biadsy, Sandyston, NJ (US); Parisa Haghani, Atlanta, GA (US); Neeraj Gaur, Jersey City, NJ (US); Sean Csukas, New York, NY (US); Peng Chen, Beijing (CN); Jia Guo, Mountain View, CA (US); Kartik Audhkhasi, Mount Kisco, NY (US); Virat Vishnu Shejwalkar, Amherst, MA (US); Arun Narayanan, Milpitas, CA (US); Youzheng Chen, Mountain View, CA (US); Bhuvana Ramabhadran, Mt. Kisco, NY (US)

(73) Assignee: GDM Holding LLC, Mountain View, CA (US)

(21) Appl. No.: 19/551,919

(22) Filed: Feb. 27, 2026

Related U.S. Application Data
(60) Provisional application No. 63/784,907, filed on Apr. 7, 2025.

(51) Int. Cl. G10L 15/06; G10L 15/08

(52) U.S. Cl. CPC G10L 15/063; G10L 15/08

(57) ABSTRACT

A method includes obtaining a training dataset including a plurality of training utterances each paired with a corresponding transcription. For each respective training utterance the operations include generating, using a large language model (LLM), a corresponding speech recognition result of the respective training utterance; determining a corresponding ground-truth histogram based on the corresponding transcription, determining a corresponding prediction histogram based on the corresponding speech recognition result; and determining a corresponding word-level hallucination loss based on the corresponding ground-truth histogram and the corresponding prediction histogram. The corresponding ground-truth histogram represents a number of occurrences of each token in the corresponding transcription, while the corresponding prediction histogram represents a number of occurrences of each token in the corresponding speech recognition result. The method also include training the LLM on the corresponding word-level hallucination loss determined for each respective training utterance of the plurality of training utterances.

### CROSS-REFERENCE TO RELATED APPLICATIONS

This U.S. Patent Application claims priority under 35 U.S.C. § 119(e) to U.S. Provisional Application 63/784,907, filed on Apr. 7, 2025. The disclosure of this prior application is considered part of the disclosure of this application and is hereby incorporated by reference in its entirety.

### TECHNICAL FIELD

This disclosure relates to detecting and reducing hallucinations in audio large language models.

### BACKGROUND

Automatic speech recognition (ASR) systems have seen significant advancements in recent years, particularly with the advent of multimodal large language models (LLMs). These models have achieved state-of-the-art word error rates (WER), making them highly effective in transcribing spoken language into text. The integration of multimodal capabilities has further enhanced the performance of ASR systems by allowing them to process and interpret a variety of input types, such as audio and visual data, thereby improving the accuracy and robustness of speech recognition. Despite these advancements, ASR systems are not without their challenges. One of the most prolific issues is the phenomenon of “hallucination,” where the system generates outputs that are inaccurate or entirely fabricated. Such inaccuracies undermine the reliability of ASR systems, particularly in applications where precision and context are critical.

### SUMMARY

One aspect of the disclosure provides a computer-implemented method that when executed on data processing hardware causes the data processing hardware to perform operations that include obtaining a training dataset that includes a plurality of training utterances each paired with a corresponding transcription. For each respective training utterance of the plurality of training utterances, the operations also include generating, using a large language model (LLM), a corresponding speech recognition result of the respective training utterance; determining a corresponding ground-truth histogram based on the corresponding transcription; determining a corresponding prediction histogram based on the corresponding speech recognition result; and determining a corresponding word-level hallucination loss based on the corresponding ground-truth histogram and the corresponding prediction histogram. The corresponding ground-truth histogram represents a number of occurrences of each token in the corresponding transcription, while the corresponding prediction histogram represents a number of occurrences of each token in the corresponding speech recognition result. The operations also include training the LLM on the corresponding word-level hallucination loss determined for each respective training utterance of the plurality of training utterances.

Implementations of the disclosure may include one or more of the following optional features. In some implementations, the operations also include obtaining a spoken utterance and generating, using the trained LLM, a speech recognition hypothesis based on the spoken utterance.

In some examples, the operations also include, for each respective training utterance of the plurality of training utterances, determining a corresponding cross-entropy loss based on the corresponding transcription and the corresponding speech recognition result. Here, the LLM is further trained on the corresponding cross-entropy loss determined for each respective training utterance of the plurality of training utterances. In these examples, the operations may further include determining a weighted loss based on the corresponding word-level hallucination loss determined for each respective training utterance of the plurality of training utterances and the corresponding cross-entropy loss determined for each respective training utterance of the plurality of training utterances, such that the LLM is further trained on the weighted loss.

In some implementations, the operations also include determining a dataset-level hallucination loss based on each training data utterance in the training dataset. Here, the LLM is further trained on the dataset-level hallucination loss. In these implementations, determining the dataset-level hallucination loss may include, for each respective training utterance of the plurality of training utterances: shifting the corresponding speech recognition result by a predetermined number of tokens; comparing the corresponding shifted speech recognition result to the corresponding transcription; and generating a classification for the respective training utterance based on comparing the corresponding shifted speech recognition result to the corresponding transcription, such that the classification represents whether the respective training utterance is a repetition hallucination error. Alternatively, determining the dataset-level hallucination loss may include, for each respective training utterance of the plurality of training utterances: determining a corresponding first language identifier for the corresponding speech recognition result; determining a corresponding second language identifier for the corresponding transcription; and generating a classification for the respective training utterance based on the corresponding first language identifier and the corresponding second language identifier for the corresponding transcription. Alternatively, determining the dataset-level hallucination loss includes, for each respective training utterance of the plurality of training utterances: determining, using an external language model, a corresponding perplexity score for the corresponding speech recognition result based on the corresponding transcription; and generating a classification for the respective training utterance based on the corresponding perplexity score.

The LLM may include a multimodal LLM. The LLM may include a stack of conformer layers or transformer layers.

Another aspect of the disclosure provides a system that includes data processing hardware and memory hardware storing instructions that when executed on the data processing hardware causes the data processing hardware to perform operations. The operations include obtaining a training dataset that includes a plurality of training utterances each paired with a corresponding transcription. For each respective training utterance of the plurality of training utterances, the operations also include generating, using a large language model (LLM), a corresponding speech recognition result of the respective training utterance; determining a corresponding ground-truth histogram based on the corresponding transcription; determining a corresponding prediction histogram based on the corresponding speech recognition result; and determining a corresponding word-level hallucination loss based on the corresponding ground-truth histogram and the corresponding prediction histogram. The corresponding ground-truth histogram represents a number of occurrences of each token in the corresponding transcription, while the corresponding prediction histogram represents a number of occurrences of each token in the corresponding speech recognition result. The operations also include training the LLM on the corresponding word-level hallucination loss determined for each respective training utterance of the plurality of training utterances.

Implementations of the disclosure may include one or more of the following optional features. In some implementations, the operations also include obtaining a spoken utterance and generating, using the trained LLM, a speech recognition hypothesis based on the spoken utterance.

In some examples, the operations also include, for each respective training utterance of the plurality of training utterances, determining a corresponding cross-entropy loss based on the corresponding transcription and the corresponding speech recognition result. Here, the LLM is further trained on the corresponding cross-entropy loss determined for each respective training utterance of the plurality of training utterances. In these examples, the operations may further include determining a weighted loss based on the corresponding word-level hallucination loss determined for each respective training utterance of the plurality of training utterances and the corresponding cross-entropy loss determined for each respective training utterance of the plurality of training utterances, such that the LLM is further trained on the weighted loss.

In some implementations, the operations also include determining a dataset-level hallucination loss based on each training data utterance in the training dataset. Here, the LLM is further trained on the dataset-level hallucination loss. In these implementations, determining the dataset-level hallucination loss may include, for each respective training utterance of the plurality of training utterances: shifting the corresponding speech recognition result by a predetermined number of tokens; comparing the corresponding shifted speech recognition result to the corresponding transcription; and generating a classification for the respective training utterance based on comparing the corresponding shifted speech recognition result to the corresponding transcription, such that the classification represents whether the respective training utterance is a repetition hallucination error. Alternatively, determining the dataset-level hallucination loss may include, for each respective training utterance of the plurality of training utterances: determining a corresponding first language identifier for the corresponding speech recognition result; determining a corresponding second language identifier for the corresponding transcription; and generating a classification for the respective training utterance based on the corresponding first language identifier and the corresponding second language identifier for the corresponding transcription. Alternatively, determining the dataset-level hallucination loss includes, for each respective training utterance of the plurality of training utterances: determining, using an external language model, a corresponding perplexity score for the corresponding speech recognition result based on the corresponding transcription; and generating a classification for the respective training utterance based on the corresponding perplexity score.

The LLM may include a multimodal LLM. The LLM may include a stack of conformer layers or transformer layers.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example architecture of a large language model.

FIG. 3A is a schematic view of an example word-level training process.

FIG. 3B is a schematic view of an example dataset-level training process.

FIG. 4 is a flowchart of an example arrangement of operations for a computer-implemented method of detecting and reducing hallucinations in audio large language models.

FIG. 5 is a schematic view of an example computing device that may be used to implement the systems and methods described herein.

Like reference symbols in the various drawings indicate like elements.

### DETAILED DESCRIPTION

In recent years, automatic speech recognition (ASR) has experienced remarkable progress, largely driven by the development and implementation of multimodal large language models (LLMs). These sophisticated models have set new benchmarks in terms of word error rates (WER), significantly enhancing the ability of ASR systems to transcribe spoken language into text with high accuracy. The incorporation of multimodal capabilities, which enable the processing and interpretation of diverse input types such as audio and visual data, has further bolstered the performance of ASR systems. The multimodal approach allows for a more comprehensive understanding of the context and nuances of spoken language, thereby improving the overall robustness and reliability of speech recognition technologies.

However, despite these technological advancements, ASR systems continue to face significant challenges. One of the most pressing issues is the phenomenon known as “hallucination.” In the context of ASR, hallucination refers to the generation of outputs that are either inaccurate or entirely fabricated by the ASR system. Such erroneous outputs may occur even when the input data is clear and unambiguous, leading to a substantial degradation in the reliability of the ASR system. Hallucinations are particularly problematic in scenarios where precisions and contextual accuracy are paramount, such as in legal transcriptions, medical dictations, and real-time communications.

The occurrence of hallucinations in ASR systems may be attributed to several factors. These factors include the inherent complexity of natural language, the variability in speech patterns among different speakers, and the limitations of current model architectures in fully capturing the intricacies of human language. Additionally, the integration of multimodal data, while beneficial in many respects, introduces new layers of complexity that may exacerbate the issue of hallucination. For instance, discrepancies between audio, textual, and visual inputs may lead to conflicting interpretations, resulting in the generation of inaccurate or nonsensical text. Addressing the problem of hallucination is important for the continued advancement and adoption of ASR technologies. Ensuring the accuracy and reliability of these systems is essential for effective deployment in various high-stakes applications. As such, there is a growing need to detect and mitigate hallucinations, thereby enhancing the overall performance and trustworthiness of ASR systems.

Accordingly, implementations herein are directed towards ta training process for training a large language model (LLM) to mitigate hallucinations when performing speech recognition. The training process obtains a training dataset including a plurality of training utterances each paired with a corresponding transcription. For each respective training utterance the training process generates a corresponding speech recognition result of the respective training utterance using the LLM, determines a corresponding ground-truth histogram based on the corresponding transcription, determines a corresponding prediction histogram based on the corresponding speech recognition result, and determines a corresponding word-level hallucination loss based on the corresponding ground-truth token histogram and the corresponding predicted token histogram. The training process trains the LLM on the corresponding word-level hallucination loss determined for each respective training utterance of the plurality of training utterances.

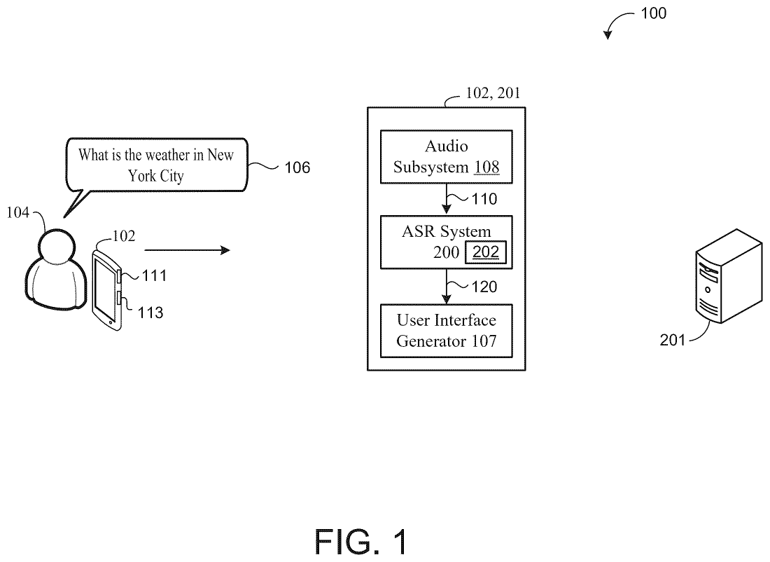

FIG. 1 illustrates a system 100 including a user device 102 of a user 104 and an automated speech recognition (ASR) system 200 implementing a large language model (LLM) 202 that resides on the user device 102 and/or on a remote computing device 201 (e.g., one or more servers of a distributed system executing in a cloud-computing environment) in communication with the user device 102. In other examples, the ASR system 200 may employ an ASR model in addition to, or in lieu of, the LLM 202. While the present disclosure discloses the ASR system 200 implementing a LLM 202, the ASR system 200 may implement other types of sequence processing neural network models other than LLMs. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 200. In the example shown, the user speaks a respective utterance 106 in a natural language of English for the phrase “What is the weather in New York City?” and the audio subsystem 108 converts the utterance 106 into corresponding acoustic frames 110 for input to the ASR system 200. Thereafter, the LLM 202 receives, as input, the acoustic frames 110 corresponding to the utterance 106, and generates/predicts, as output, a corresponding transcription 120 (e.g., speech recognition result/hypothesis) of the utterance 106. In the example shown, the user device 102 and/or the remote computing device 201 also executes a user interface generator 107 configured to present a representation of the speech recognition result 120 of the utterance 106 to the user 104 of the user device 102. In some configurations, the speech recognition result 120 output from the ASR system 200 is processed, e.g., by a natural language understanding (NLU) module executing on the user device 102 or the remote computing device 201, to execute a user command. Additionally or alternatively, a text-to-speech system (e.g., executing on any combination of the user device 102 or the remote computing device 201) may convert the transcription into synthesized speech for audible output by another device. For instance, the original utterance 106 may correspond to a message the user 104 is sending to a friend in which the speech recognition result 120 is converted to synthesized speech for audible output to the friend to listen to the message conveyed in the original utterance 106.

In some implementations, the LLM 202 includes a multimodal LLM capable of processing and generating outputs based on multiple modalities, such as audio, text, and visual data. For example, the LLM 202 may receive not only encoded representations 212 of acoustic frames 110, but also corresponding visual data, such as images or videos, to improve the accuracy of the speech recognition result 120 and reduce hallucinations. The multimodal processing allows the LLM 202 to leverage contextual information from different sources, leading to more robust and accurate outputs. Moreover, the LLM 202 may include a stack of conformer layers (e.g., a conformer model), which is a hybrid architecture combining the strengths of convolutional neural networks (CNNs) and transformers. A conformer model effectively captures both local and global dependencies in the input data, making the LLM 202 particularly well-suited for audio processing tasks. In particular, the convolutional layers in a conformer model are adept at capturing local features, such as phonemes and short-term acoustic patterns, while the transformer layers excel at capturing long-range dependencies, such as sentence structure and semantic context. The combination of local and global feature extraction enhances the ability of the LLM 202 to accurately transcribe and understand spoken language. In other examples, the LLM 202 includes a stack of multi-head attention layers other than conformer layers, such as transformers.

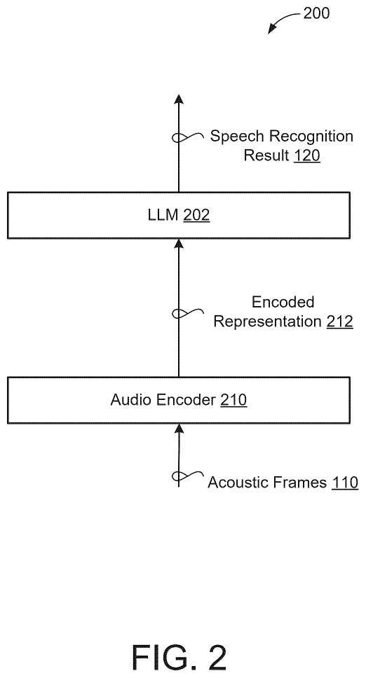

FIG. 2 illustrates an example of the ASR system 200 including an audio encoder 210 and the LLM 202 overlain on the audio encoder 210 that serves as a speech decoder. For instance, the audio encoder 210 reads a sequence of d-dimensional feature vectors (e.g., acoustic frames 110 (FIG. 1) x=(x₁, x₂, . . . , x_{T}), where xₜ∈ [symbol] , and produces at each output step an encoded representation 212. The LLM 202, which is overlain on the audio encoder 210, receives the encoded representations 212, as input, and generates the speech recognition result 120 based on the encoded representation 212. Thereafter, the LLM 202 generates the speech recognition result 120 based on the encoded representation 212. The combination of the audio encoder 210 and the LLM 202 allows for an end-to-end speech recognition system that leverages both acoustic modeling (via the audio encoder 210) and language modeling (via the LLM 202). In some implementations, the LLM 202 includes a prediction network (not shown) which, like a language model (LM), processes the sequence of non-blank symbols output by a final Softmax layer so far into a dense representation. In these implementations, the representations produced by the audio encoder 210 and the prediction network are combined by the LLM 202 whereby the LLM 202 serves as a joint network to form a Recurrent Neural Network-Transducer (RNN-T) model architecture.

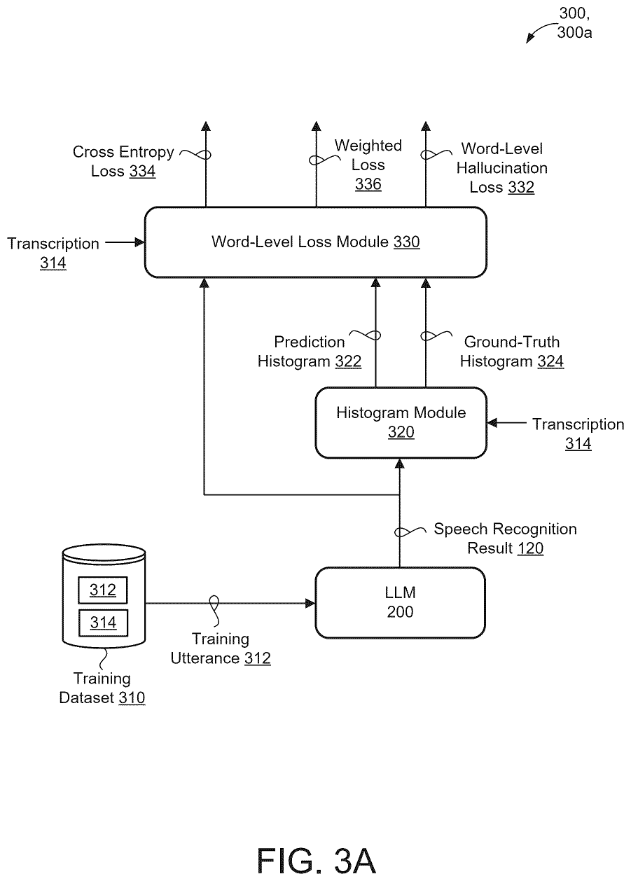

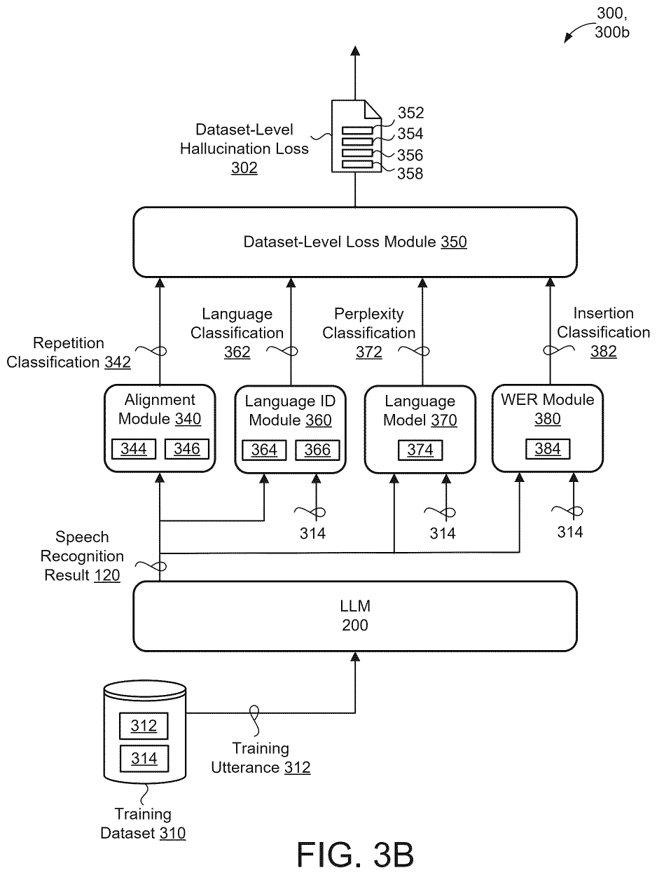

FIGS. 3A and 3B illustrate an example training process 300. The training process 300 may train the LLM 202 using a training dataset 310. The training process 300 may obtain the training dataset 310 that includes a plurality of training utterances 312 each paired with a corresponding transcription 314. Each training utterance 312 represents a segment of spoken language, which may range in length from a single phoneme or word or to a full sentence, paragraph, or even a longer discourse. The training utterances 312 may include synthetic speech generated by a text-to-speech system or non-synthetic speech (i.e., human speech) recorded from various sources. The corresponding transcription 314 provides a textual representation of the content of the training utterance 312, serving as the ground-truth label for evaluating the performance of the LLM 202. For each respective training utterance 312 of the plurality of training utterances 312, the LLM 202 generates a corresponding speech recognition result 120 of the respective training utterance 312.

For simplicity, the training process includes a word-level loss part 300a (FIG. 3A) and a dataset-level loss part 300b (FIG. 3B). The word-level loss part 300a determines losses for each individual training utterance 312 within the training dataset 310. This granular approach allows for precise adjustments to the LLM 202 based on the accuracy of the speech recognition results 120 for each specific training utterance 312. In contrast, the dataset-level loss part 300b determines losses based on the aggregate performance of the LLM 202 across the entire training dataset 310. This holistic approach enables the training process 300 to identify and address broader patterns of hallucination or inaccuracy. For example, if the dataset-level loss part 300b determines that over a threshold value (e.g., 70%) of the training utterances 312 are classified as hallucinations, the training process 300 may adjust the training parameters to prioritize the reduction of this specific type of error. The LLM 202 may be trained using any combination of losses derived from the word-level loss part 300a and the dataset-level loss part 300b, allowing for a flexible and adaptive training strategy.

Referring now specifically to FIG. 3A, in some implementations, the word-level loss part 300a employs the LLM 202, a histogram module 320, and a word-level loss module 330. For each respective training utterance 312, the histogram module 320 determines a corresponding prediction histogram 322 based on the corresponding speech recognition result 120. The corresponding prediction histogram 322 represents a number of occurrences of each token in the corresponding speech recognition result 120. A token, in this context, represents a linguistic unit, such as a word, subword, or character (i.e., letter). For example, if the speech recognition result 120 is “the dog chased the ball,” then the corresponding prediction histogram 322 has a token count of 2 for “the,” a token count of 1 for “dog,” a token count of 1 for “chased”, and a token count of 1 for “ball.” Moreover, for each respective training utterance 312, the histogram module 320 determines a corresponding ground-truth histogram 324 based on the corresponding transcription 314 of the respective training utterance 312. The corresponding ground-truth histogram 324 represents a number of occurrences of each token in the corresponding transcription 314. For example, if the corresponding transcription 314 is “the cat chased the ball,” then the corresponding ground-truth histogram 324 has a token count of 2 for “the,” a token count of 1 for “cat,” a token count of 1 for “chased”, and a token count of 1 for “ball.”

The word-level loss module 330 determines a corresponding word-level hallucination loss 332 based on the corresponding ground-truth histogram 324 and the corresponding prediction histogram 322. More specifically, the word-level loss module 330 determines the difference between the token counts in the prediction histogram 322 and the ground-truth histogram 324 for each unique token present in either histogram. For example, if the prediction histogram 322 indicates that the token “dog” occurs once, but the ground-truth histogram 324 indicates that the token “dog” occurs zero times, this discrepancy contributes to the word-level hallucination loss 332. Similarly, if the prediction histogram 322 includes the token “elephant” which does not appear in the ground-truth histogram 324, this will also contribute to the word-level hallucination loss 332. Notably, the word-level hallucination loss 332 only considers the counts of each token, and disregards the positional information or order of the tokens within each sequence. In essence, the word-level hallucination loss 332 measures how many extra or missing tokens the LLM 202 generates compared to the correct transcription 314.

The word-level loss module 330 may employ various distance metrics, such as the mean squared error or the cross-entropy loss, to quantify the difference between the two histograms. A higher word-level hallucination loss 332 indicates a greater discrepancy between the speech recognition result 120 and the transcription 314, suggesting a higher degree of hallucination. More specifically, the mean squared error determines the average of the squares of the differences between the token counts in the two histograms. The cross-entropy loss measures the difference between two probability distributions, treating the histograms as probability distributions over tokens. The Kullback-Leibler divergence measures how one probability distribution diverges from a second, expected probability distribution. Cosine distance measures the similarity between the two histograms as vectors.

The training process 300 trains the LLM 202 on the corresponding word-level hallucination loss 332 determined for each respective training utterance 312 of the plurality of training utterances 312. By minimizing the word-level hallucination loss 332, the training process 300 encourages the LLM 202 to generate speech recognition results 120 that more closely align with the transcriptions 314, thereby reducing the occurrence of hallucinations. The training process 300 iteratively adjusts the parameters of the LLM 202 using techniques such as gradient descent, based on the calculated loss values. In particular, gradient descent adjusts the weights and biases of the LLM 202 in the direction that reduces the word-level hallucination loss 332. This adjustment is repeated over many iterations, refining the ability of the LLM 202 to accurately transcribe speech and minimize hallucinations.

Moreover, for each respective training utterance 312, the word-level loss module 330 may determine a corresponding cross-entropy loss 334 based on the corresponding transcription 314 and the corresponding speech recognition result 120, The word-level loss module 330 may determine the cross-entropy loss 334 by comparing the speech recognition result 120 to the corresponding transcription 314 to check for accuracy. In some examples, the cross-entropy loss 334 represents the difference between the probability distributions of the tokens in the transcription 314 and the speech recognition result 120. This loss function evaluates how well the LLM 202 predicts the correct sequence of tokens in the transcription 314. For example, if the transcription 314 is “the cat sat” and the speech recognition result 120 is “the bat sat,” the cross-entropy loss 334 will be higher than if the speech recognition result 120 was “the cat sat.” To illustrate, the cross-entropy loss 334 calculates the negative log-likelihood of the correct tokens from the transcription 314 given the predicted token probabilities from the speech recognition result 120. If the LLM 202 assigns a low probability to the correct token “cat” in the second position and a high probability to the incorrect token “bat,” the cross-entropy loss 334 will increase.

The training process 300 trains the LLM 202 to minimize the cross-entropy loss 334 by adjusting parameters of the LLM 202 to increase the probability of generating the correct tokens. Here, the training process 300 trains the LLM 202 on the corresponding cross-entropy loss 334 determined for each respective training utterance 312 of the plurality of training utterances 312 in addition to, or in lieu of, the word-level hallucination losses 332. This allows the LLM 202 to learn both the overall token distribution through the word-level hallucination loss 332, and the sequential accuracy of the tokens through the cross-entropy loss 334. Therefore, the LLM 202 may learn to produce speech recognition results 120 that are both statistically similar to the transcription 314 in token frequency, and sequentially accurate in token order.

The training process 300 may further determine a weighted loss 336 based on the corresponding word-level hallucination loss 332 and the corresponding cross-entropy loss 334. The weighted loss 336 allows for a flexible balance between minimizing token frequency discrepancies and maximizing sequential accuracy. For instance, the training process 300 may assign a higher weight to the word-level hallucination loss 332 during initial training phases to ensure the large language model 202 learns accurate token frequencies. Subsequently, the training process 300 may increase the weight of the cross-entropy loss 334 to refine the sequential accuracy of the speech recognition results 120. Alternatively, the training process 300 may dynamically adjust the weights based on the performance of the large language model 202. For example, if the large language model 202 exhibits high hallucination rates, the training process 300 may increase the weight of the word-level hallucination loss 332. Conversely, if the large language model 202 struggles with sequential accuracy, the training process 300 may increase the weight of the cross-entropy loss 334. By training the large language model 202 on this weighted loss 336, the training process 300 enables the large language model 202 to learn both accurate token distributions and precise token sequences, thereby minimizing hallucinations and improving overall transcription accuracy.

Referring now to FIG. 3B, in some implementations, the dataset-level loss part 300b employs the LLM 202, an alignment module 340, a dataset-level loss module 350, a language identification module 360, an external language model 370, and a word error rate (WER) module 380. The dataset-level loss part 300b determines dataset-level hallucination losses 302 and trains the LLM 202 on the dataset-level hallucination losses 301. That is, the dataset-level hallucination losses 302 are based on the entire training dataset 310 rather than individual training utterances 312. The dataset-level hallucination loss 302 may include at least one of a repetition hallucination loss 352, a language hallucination loss 354, a perplexity hallucination loss 356, and an insertion hallucination loss 358. The dataset-level loss part 300b may train the LLM 202 on any combination of losses from the dataset-level hallucination loss 302. For each respective training utterance 312 the LLM 202 determines a corresponding speech recognition result 120.

A key type of hallucination that the training process 300 aims to detect and mitigate is repetition hallucination. Repetition hallucination occurs when the LLM 202 generates a sequence of output tokens that are repeated for a specific number of times, deviating from the expected speech recognition result 120. For example, the LLM 202 may incorrectly output “yes yes yes yes.” instead of simply “yes,” demonstrating a clear repetition hallucination. To detect such hallucinations, for each respective training utterance 312, the alignment module 340 shifts the corresponding speech recognition result 120 by a predetermined number of tokens to generate a shifted speech recognition result 344. The shifting allows for direct comparison of token sequences with the hypothesis itself. Simply put, the shifting operation creates a temporally offset version of the speech recognition result 120, allowing for a direct, token-wise comparison of overlapping segments within the speech recognition result 120 itself.

Thereafter, the alignment module 340 compares the corresponding shifted speech recognition result 344 to the original corresponding speech recognition result 120 to identify instances where identical token sequences are repeated. Based on the comparison, the alignment module 340 generates a repetition classification 342 for the respective training utterance 312, representing whether the respective training utterance 312 is a repetition hallucination error or not. More specifically, the alignment module 340 determines the repetition classification 342 by determining a similarity score 346 between the shifted speech recognition result 344 and the unshifted speech recognition result 120. The similarity score 346 quantifies the degree of overlap between the original speech recognition result 120 and shifted speech recognition result 344, thereby revealing the presence and extent of repetitions. The similarity score 346 may be represented as the number of identical tokens between the shifted and unshifted hypotheses, normalized by the length of the unshifted hypothesis. The normalization ensures that the similarity score 346 is independent of the length of the utterance, allowing for consistent comparisons across different utterances. If the similarity score 346 exceeds a predetermined repetition threshold, the training utterance 312 is classified a repetition hallucination error.

In some examples, the alignment module 340 iteratively shifts the speech recognition result 120 by the predetermined number of tokens, performing a comparison at each shift, to identify repetitions of varying lengths and complexities within the speech recognition result 120. The iterative approach allows for the detection of not only simple, directly adjacent repetitions but also more complex patterns where the repeated sequence may be separated by other tokens. For instance, consider the speech recognition result 120 “the cat sat on the mat the cat sat on the mat.” A single shift may only reveal the repetition of “the,” while multiple shifts would be required to detect the full, longer repetition of “the cat sat on the mat.” By iteratively shifting and comparing, the alignment module 340 may effectively capture these intricate repetition patterns, providing a more comprehensive assessment of potential hallucination errors. Thus, the iterative approach allows for the detection of repetitions of varying lengths and complexities within the speech recognition result 120. For instance, consider the hypothesis “How are you um um um um um um um um.” By shifting the speech recognition result 120 and comparing the shifted speech recognition result 344 to the speech recognition result 120, alignment module 340 may determine if the repetition of “um” constitutes a hallucination based on the defined threshold. This process is repeated for each training utterance 312 such that the alignment module 340 generates a repetition classification 342 for each respective training utterance 312.

The dataset-level loss module 350 receives the repetition classification 342, which indicates whether each respective training utterance 312 is classified as a repetition hallucination or not, and aggregates this information to compute a dataset-level language hallucination loss 362. Specifically, the dataset-level loss module 350 counts the number of training utterances 312 that have been classified as exhibiting repetition hallucinations based on the repetition classification 342. The dataset-level loss module 350 uses the count to determine the repetition hallucination loss 352, which represents the overall prevalence of repetition hallucinations within the entire training dataset 310. For example, the dataset-level loss module 350 may determine the repetition hallucination loss 352 as the ratio of the number of hallucination classifications to the total number of training utterances 312 in the dataset, or as a more complex function that weighs the severity of repetitions. Moreover, the dataset-level loss module 350 may apply a threshold to the repetition hallucination loss 352. If the repetition hallucination loss 352 exceeds a predetermined threshold, indicating a significant presence of repetition hallucinations in the dataset, the training process 300 triggers a training update of the LLM 202. That is, the training process 300 may adjust the parameters of the LLM 202 to mitigate the identified repetition hallucination patterns based on the repetition hallucination loss 352. The threshold ensures that the training update is only initiated when the level of repetition hallucinations is deemed problematic, preventing unnecessary parameter adjustments when the dataset exhibits acceptable performance.

In some implementations, the training process 300 trains the LLM 202 on a language hallucination loss 354. Here, the training process 300 employs the language identification module 360 that performs language identification for each corresponding speech recognition result 120 and the corresponding transcription 314 to detect potential discrepancies that indicate hallucinations. Specifically, the training process 300 may employ the language identification module 360 to determine a corresponding first language identifier 364 for the corresponding speech recognition result 120 and a corresponding second language identifier 366 for the corresponding transcription 314. For example, if language identification module 360 determines that the speech recognition result 120 is in “English,” the first language identifier 364 will reflect the English language. Moreover, if the language identification module 360 determines that the corresponding transcription 314 is in “Spanish,” the second language identifier 366 will reflect the Spanish language. The language mismatch serves as a strong indicator of a potential hallucination, where the LLM 202 has deviated from the spoken language in the input audio. To illustrate, consider a scenario where the transcription 314 is “Hello, how are you?” resulting in a second language identifier 366 of “English.” For the corresponding training utterance 312 spoken in English, the LLM 202 may generate the speech recognition result 120 of “Bonjour, comment ça va?” resulting in the first language identifier 364 of “French.” This mismatch signals a significant deviation.

Thereafter, the language identification module 360 generates a language classification 362 for the respective training utterance 312 based on the corresponding first language identifier and the corresponding second language identifier. The language classification 362 may be a binary value (e.g., 0 for match, 1 for mismatch).

The dataset-level loss module 350 receives the language classification 362, which indicates whether each respective training utterance 312 is classified as a language hallucination or not, and aggregates this information to compute a dataset-level language hallucination loss 354. Specifically, the dataset-level loss module 350 counts the number of training utterances 312 that have been classified as exhibiting language hallucinations based on the language classification 362. The dataset-level loss module 350 uses the count to determine the language hallucination loss 354, which represents the overall prevalence of language hallucinations within the entire training dataset 310. For example, the dataset-level loss module 350 may determine the language hallucination loss 354 as the ratio of the number of hallucination classifications to the total number of training utterances 312 in the dataset. Moreover, the dataset-level loss module 350 may apply a threshold to the language hallucination loss 354. If the language hallucination loss 354 exceeds a predetermined threshold, indicating a significant presence of language hallucinations in the dataset, the training process 300 triggers a training update of the LLM 202 based on the language hallucination loss 354. That is, the training process 300 may adjust the parameters of the LLM 202 to mitigate the identified language hallucination patterns. The threshold ensures that the training update is only initiated when the level of language hallucinations is deemed problematic, preventing unnecessary parameter adjustments when the dataset exhibits acceptable performance.

Another type of hallucination that the training process 300 aims to detect and mitigate is a perplexity hallucination. Perplexity hallucination, in this context, refers to the generation of output by the LLM 202 that, while grammatically coherent and locally probable, deviates from the intended or factually accurate output. This deviation manifests in two primary forms. First, is an overextension or continuation of a sequence of output tokens beyond the scope of the intended result. For instance, given an intended speech recognition result 120 of “Hey, how are you?”, the LLM 202, exhibiting perplexity hallucination, may generate an extended, albeit contextually related, sequence such as “Hey, how are you? I am good. What about you? I am good, too. Nice weather. Yeah, the weather is really nice today. Do you have any plans for the weekend? Not yet.” This overextension is characterized by the tendency of the LLM 202 to continue generating tokens that maintain a high degree of local perplexity, meaning each subsequent token is highly probable given the preceding sequence, but the overall generated output diverges from the desired brevity and specificity. Second, perplexity hallucination may manifest as an unintended correction of a speech recognition result 120, even when such correction is factually accurate but not the intended output. For instance, if the speech recognition result 120 is intentionally set to the factually incorrect statement “New York City is on the west coast” for the purpose of testing the ability of the LLM 202 to reproduce a verbatim input, the LLM 202 may inadvertently alter the result to the factually correct statement “New York City is on the east coast.” This type of perplexity hallucination illustrates the tendency of the LLM 202 to prioritize factual accuracy, or perceived factual accuracy, over strict adherence to the provided input, even when the input is intentionally flawed. Both forms of perplexity hallucination underscore the need for the training process 300 to effectively discern and mitigate instances where the LLM 202, while generating statistically probable tokens, produces outputs that deviate from the intended or desired outcome.

To that end, the training process 300 may employ an external language model 370 to analyze and classify the perplexity characteristics of each speech recognition result 120. In particular, for each respective training utterance 312, the external language model 370 receives as input both the corresponding speech recognition result 120 and the corresponding transcription 314. Here, the external language model 370 performs a comparative analysis, evaluating the statistical likelihood of the speech recognition result 120 within the context of the corresponding transcription 314. This analysis involves determining a perplexity score 374 of the speech recognition result 120, which is a measure of how well the LLM 202 predicts the input sequence. A high perplexity score 374 indicates that the input sequence is statistically improbable according to the external language model 370, suggesting a potential deviation from the expected output. Conversely, a low perplexity score 374 indicates that the input sequence is statistically probable, suggesting closer adherence to the expected output. Based on this perplexity analysis, the external language model 370 generates a corresponding perplexity classification 372, which categorizes the observed deviation as either indicative of a perplexity hallucination or not. The perplexity classification 372 may further include sub-classifications, such as distinguishing between overextension hallucinations and unintended correction hallucinations. The external language model 370, which may be another LLM or a smaller, specialized language model (SLM), is chosen based on its ability to accurately assess the statistical likelihood of token sequences and effectively differentiate between intended and unintended deviations.

The dataset-level loss module 350 receives the perplexity classification 372, which indicates whether each respective training utterance 312 is classified as a perplexity hallucination or not, and aggregates this information to compute a dataset-level perplexity hallucination loss 356. Specifically, the dataset-level loss module 350 counts the number of training utterances 312 that have been classified as exhibiting perplexity hallucinations based on the perplexity classification 372. The dataset-level loss module 350 uses the count to determine the perplexity hallucination loss 356, which represents the overall prevalence of repetition hallucinations within the entire training dataset 310. For example, the dataset-level loss module 350 may determine the perplexity hallucination loss 356 as the ratio of the number of hallucination classifications to the total number of training utterances 312 in the dataset, or as a more complex function that weighs the severity of repetitions. Moreover, the dataset-level loss module 350 may apply a threshold to the perplexity hallucination loss 356. If the perplexity hallucination loss 356 exceeds a predetermined threshold, indicating a significant presence of perplexity hallucinations in the dataset, the training process 300 triggers a training update of the LLM 202 based on the perplexity hallucination loss 356. That is, the training process 300 may adjust the parameters of the LLM 202 to mitigate the identified perplexity hallucination patterns. The threshold ensures that the training update is only initiated when the level of perplexity hallucinations is deemed problematic, preventing unnecessary parameter adjustments when the dataset exhibits acceptable performance.

In some implementations, the training process 300 aims to detect and mitigate instances of insertion hallucination errors, which occur when the LLM 202 incorrectly inserts extraneous words or phrases into the transcribed output. To achieve this, the training process 300 incorporates a word error rate (WER) module 380 that evaluates each training utterance 312 by comparing the speech recognition result 120 with the corresponding transcription 314. This comparison yields a WER 384, a metric that quantifies the discrepancies between the two text sequences. Specifically, the WER 384 decomposes these discrepancies into three distinct error categories: insertion errors, signifying extra words; deletion errors, indicating missing words; and substitution errors, where one word is replaced by another. Notably, the WER module 380 focuses on the insertion error component of the WER 384. To isolate insertion hallucinations, the WER module 380 determines the insertion rate, which represents the frequency of insertion errors within the WER 384. The WER module 380 compares the insertion rate against a predefined insertion rate threshold, a configurable parameter that sets the tolerance level for insertion errors. If the calculated insertion rate exceeds the insertion rate threshold, the insertion rate indicates a significant presence of insertion hallucinations. Based on this comparison, the WER module 380 generates an insertion classification 382, a binary or multi-class label that categorizes each utterance as either exhibiting or not exhibiting excessive insertion errors, or indicating different severities of insertion errors.

The dataset-level loss module 350 receives the insertion classification 382, which indicates whether each respective training utterance 312 is classified as a insertion hallucination or not, and aggregates this information to compute a dataset-level insertion hallucination loss 358. Specifically, the dataset-level loss module 350 counts the number of training utterances 312 that have been classified as exhibiting insertion hallucinations based on the insertion classifications 382. The dataset-level loss module 350 uses the count to determine the insertion hallucination loss 358, which represents the overall prevalence of insertion hallucinations within the entire training dataset 310. For example, the dataset-level loss module 350 may determine the insertion hallucination loss 358 as the ratio of the number of hallucination classifications to the total number of training utterances 312 in the dataset. Moreover, the dataset-level loss module 350 may apply a threshold to the insertion hallucination loss 358. If the insertion hallucination loss 358 exceeds a predetermined threshold, indicating a significant presence of insertion hallucinations in the dataset, the training process 300 triggers a training update of the LLM 202 based on the insertion hallucination loss 358. That is, the training process 300 may adjust the parameters of the LLM 202 to mitigate the identified insertion hallucination patterns. The threshold ensures that the training update is only initiated when the level of insertion hallucinations is deemed problematic, preventing unnecessary parameter adjustments when the dataset exhibits acceptable performance.

After the training process 300 trains the LLM 202 using the training dataset 310, the resulting trained LLM 202 is configured to receive a spoken utterance 106, which represents an audio input containing human speech. Subsequently, the trained LLM 202 utilizes its learned parameters and internal representations to generate a speech recognition hypothesis 120, which is a textual transcription of the spoken utterance 106. Notably, the LLM 202 is trained during two distinct phases of the training process 300, the word-level loss part 300a (FIG. 3A) and the dataset-level loss part 300b (FIG. 3B). Therefore, the combination of word-level and dataset-level loss functions allows for a robust and nuanced training regime, enabling the LLM 202 to achieve high accuracy in speech recognition tasks.

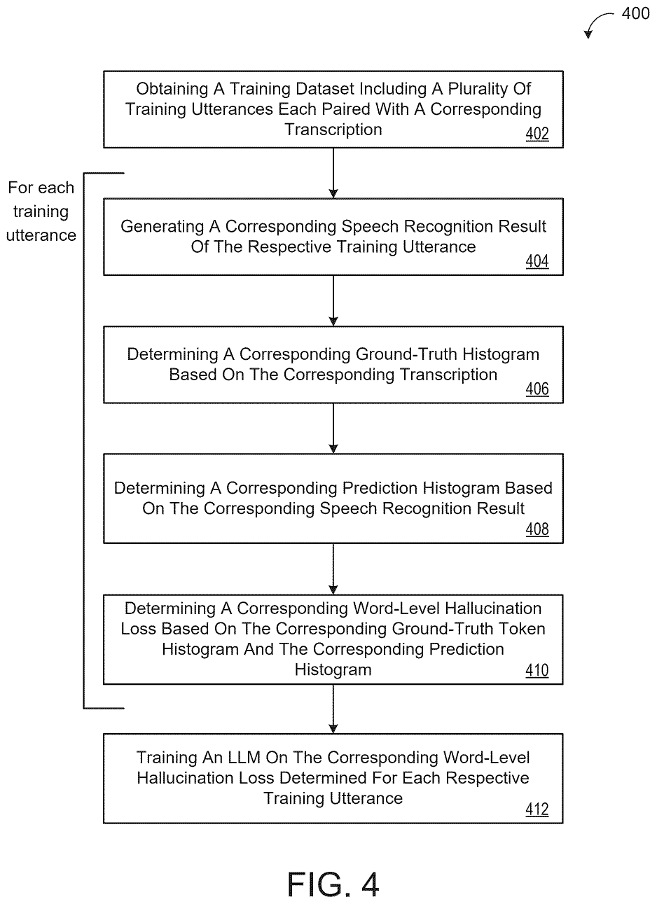

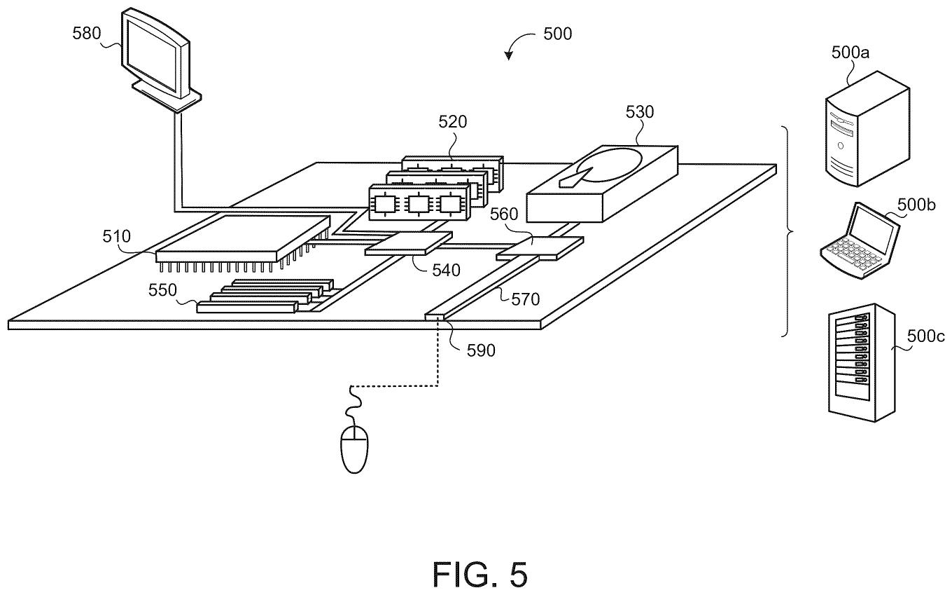

FIG. 4 is a flowchart of an example arrangement of operations for a computer-implemented method 400 of detecting and reducing hallucinations in LLMs. The method 400 may execute on data processing hardware 510 (FIG. 5) using instructions stored on memory hardware 520 (FIG. 5). The data processing hardware 510 and the memory hardware 520 may reside on the remote computing device 201 and/or the user device 102 each corresponding to a computing device 500 (FIG. 5).

At operation 402, the method 400 includes obtaining a training dataset 310 including a plurality of training utterances 312 each paired with a corresponding transcription 314. For each respective training utterance 312 of the plurality of training utterances 312, the method 400 performs operations 404-410. At operation 404, the method 400 includes generating a corresponding speech recognition result 120 of the respective training utterance 312 using a LLM 202. At operation 406, the method 400 includes determining a corresponding ground-truth histogram 324 based on the corresponding transcription 314. The corresponding ground-truth histogram 324 represents a number of occurrences of each token in the corresponding transcription 314. At operation 408, the method 400 includes determining a corresponding prediction histogram 322 based on the corresponding speech recognition result 120. The corresponding prediction histogram 322 representing a number of occurrences of each token in the corresponding speech recognition result 120. At operation 410, the method 400 includes determining a corresponding word-level hallucination loss 332 based on the corresponding ground-truth histogram 324 and the corresponding prediction histogram 322. At operation 412, the method 400 includes training the LLM 202 on the corresponding word-level hallucination loss 332 determined for each respective training utterance 312 of the plurality of training utterances 312.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
obtaining a training dataset comprising a plurality of training utterances each paired with a corresponding transcription;
for each respective training utterance of the plurality of training utterances:
generating, using a large language model (LLM), a corresponding speech recognition result of the respective training utterance;
determining a corresponding ground-truth histogram based on the corresponding transcription, the corresponding ground-truth histogram representing a number of occurrences of each token in the corresponding transcription;
determining a corresponding prediction histogram based on the corresponding speech recognition result, the corresponding prediction histogram representing a number of occurrences of each token in the corresponding speech recognition result, and
determining a corresponding word-level hallucination loss based on the corresponding ground-truth histogram and the corresponding prediction histogram; and
training the LLM on the corresponding word-level hallucination loss determined for each respective training utterance of the plurality of training utterances.

2. The computer-implemented method of claim 1, wherein the operations further comprise:
obtaining a spoken utterance; and
generating, using the trained LLM, a speech recognition hypothesis based on the spoken utterance.

3. The computer-implemented method of claim 1, wherein the operations further comprise:
for each respective training utterance of the plurality of training utterances, determining a corresponding cross-entropy loss based on the corresponding transcription and the corresponding speech recognition result,
wherein the LLM is further trained on the corresponding cross-entropy loss determined for each respective training utterance of the plurality of training utterances.

4. The computer-implemented method of claim 3, wherein the operations further comprise:
determining a weighted loss based on the corresponding word-level hallucination loss determined for each respective training utterance of the plurality of training utterances and the corresponding cross-entropy loss determined for each respective training utterance of the plurality of training utterances,
wherein the LLM is further trained on the weighted loss.

5. The computer-implemented method of claim 1, wherein the operations further comprise:
determining a dataset-level hallucination loss based on each training data utterance in the training dataset,
wherein the LLM is further trained on the dataset-level hallucination loss.

6. The computer-implemented method of claim 5, wherein determining the dataset-level hallucination loss comprises, for each respective training utterance of the plurality of training utterances:
shifting the corresponding speech recognition result by a predetermined number of tokens;
comparing the corresponding shifted speech recognition result to the corresponding transcription; and
generating a classification for the respective training utterance based on comparing the corresponding shifted speech recognition result to the corresponding transcription, the classification representing whether the respective training utterance is a repetition hallucination error.

7. The computer-implemented method of claim 5, wherein determining the dataset-level hallucination loss comprises, for each respective training utterance of the plurality of training utterances:
determining a corresponding first language identifier for the corresponding speech recognition result;
determining a corresponding second language identifier for the corresponding transcription; and
generating a classification for the respective training utterance based on the corresponding first language identifier and the corresponding second language identifier for the corresponding transcription.

8. The computer-implemented method of claim 5, wherein determining the dataset-level hallucination loss comprises, for each respective training utterance of the plurality of training utterances:
determining, using an external language model, a corresponding perplexity score for the corresponding speech recognition result based on the corresponding transcription; and
generating a classification for the respective training utterance based on the corresponding perplexity score.

9. The computer-implemented method of claim 1, wherein the LLM comprises a multimodal LLM.

10. The computer-implemented method of claim 1, wherein the LLM comprises a stack of conformer layers or transformer layers.

11. A system comprising:
data processing hardware; and
memory hardware in communication with the data processing hardware, the memory hardware storing instructions that when executed on the data processing hardware cause the data processing hardware to perform operations comprising:
obtaining a training dataset comprising a plurality of training utterances each paired with a corresponding transcription;
for each respective training utterance of the plurality of training utterances:
generating, using a large language model (LLM), a corresponding speech recognition result of the respective training utterance;
determining a corresponding ground-truth histogram based on the corresponding transcription, the corresponding ground-truth histogram representing a number of occurrences of each token in the corresponding transcription;
determining a corresponding prediction histogram based on the corresponding speech recognition result, the corresponding prediction histogram representing a number of occurrences of each token in the corresponding speech recognition result; and
determining a corresponding word-level hallucination loss based on the corresponding ground-truth histogram and the corresponding prediction histogram; and
training the LLM on the corresponding word-level hallucination loss determined for each respective training utterance of the plurality of training utterances.

12. The system of claim 11, wherein the operations further comprise:
obtaining a spoken utterance; and
generating, using the trained LLM, a speech recognition hypothesis based on the spoken utterance.

13. The system of claim 11, wherein the operations further comprise:
for each respective training utterance of the plurality of training utterances, determining a corresponding cross-entropy loss based on the corresponding transcription and the corresponding speech recognition result,
wherein the LLM is further trained on the corresponding cross-entropy loss determined for each respective training utterance of the plurality of training utterances.

14. The system of claim 13, wherein the operations further comprise:
determining a weighted loss based on the corresponding word-level hallucination loss determined for each respective training utterance of the plurality of training utterances and the corresponding cross-entropy loss determined for each respective training utterance of the plurality of training utterances,
wherein the LLM is further trained on the weighted loss.

15. The system of claim 11, wherein the operations further comprise:
determining a dataset-level hallucination loss based on each training data utterance in the training dataset,
wherein the LLM is further trained on the dataset-level hallucination loss.

16. The system of claim 15, wherein determining the dataset-level hallucination loss comprises, for each respective training utterance of the plurality of training utterances:
shifting the corresponding speech recognition result by a predetermined number of tokens;
comparing the corresponding shifted speech recognition result to the corresponding transcription; and
generating a classification for the respective training utterance based on comparing the corresponding shifted speech recognition result to the corresponding transcription, the classification representing whether the respective training utterance is a repetition hallucination error.

17. The system of claim 15, wherein determining the dataset-level hallucination loss comprises, for each respective training utterance of the plurality of training utterances:
determining a corresponding first language identifier for the corresponding speech recognition result;
determining a corresponding second language identifier for the corresponding transcription; and
generating a classification for the respective training utterance based on the corresponding first language identifier and the corresponding second language identifier for the corresponding transcription.

18. The system of claim 15, wherein determining the dataset-level hallucination loss comprises, for each respective training utterance of the plurality of training utterances:
determining, using an external language model, a corresponding perplexity score for the corresponding speech recognition result based on the corresponding transcription; and
generating a classification for the respective training utterance based on the corresponding perplexity score.

19. The system of claim 11, wherein the LLM comprises a multimodal LLM.

20. The system of claim 11, wherein the LLM comprises a stack of conformer layers or transformer layers.
